(19) United States
(12) Patent Application Publication
(10) Pub. No.: US 2004/0262461 A1
(43) Pub. Date: Dec. 30, 2004

(54) Cable guard for securing wires with U-shaped staples

(76) Inventors: James M. Del Re, Hampshire, IL (US); Kathy Ryan, Des Plaines, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/610,073

(22) Filed: Jun. 30, 2003

(51) Int. Cl. F16B 15/00

(52) U.S. Cl. 248/71

(57) ABSTRACT

A cable guard is shown to include a bridge body and substantially parallel legs extending perpendicularly outward therefrom. The top portion of the bridge body includes a recess extending inward therefrom, and each substantially parallel leg has a respective bore therethrough. The recess of the cable guard prevents unnecessary further drive of the U-shaped staple when the U-shaped staple is sufficiently captured by the cable guard and secured onto the support surface. The bores of the parallel legs of the cable guard provide a force fit when mated with the legs of a U-shaped staple, and the inner surfaces of the parallel legs of the cable guard provide a force fit when mated with a wire. Accordingly, a unitary system comprising the cable guard, U-shaped staple, and wire allows for easy installation. The bottom surface of the cable guard can generally conform to the support surface to which it is to be secured thereto. The cable guard may also accommodate barbed staples.

### BACKGROUND OF THE INVENTION

The present invention relates to cable guards generally, and more specifically, to a cable guard for accommodating a U-shaped staple having a recess in its top portion for receiving said U-shaped staple and preventing said U-shaped staple from being driven too far into a support surface.

Electrical and communication wires are traditionally secured onto support surfaces with bare staples. Nevertheless, when driven too far, these staples or other equivalent fasteners often damage the wires either by lacerating the insulation bounded to the conductive cable or even severing or deforming the conductive cable itself, thereby causing a short or even broken circuit. In order to prevent such cable damage, conventional cable guards were developed to protect and secure wires onto various support surfaces.

Conventional cable guards used to prevent cable damage typically comprise a buffering surface positioned between the staple and the cable. For example, U.S. Pat. No. 662,587 teaches a piece of insulation in the form of a strip or cushion being placed between the staple and cable. This cable guard provides either a single or double thickness of insulation between the staple and cable. Likewise, U.S. Pat. No. 843,916 teaches an insulating saddle, which is pierced by the legs of the staple such that a single thickness of insulation is formed on the inner sides of the legs of the staple, and a double thickness of insulation is formed under the head of the staple. U.S. Pat. No. 2,003,062 teaches a metal clip which is electrically welded to the body of the staple. It is important to note that this clip serves to protect rather than cushion the conductor. U.S. Pat. No. 4,697,045 and Des. 298,916 further teach a sleeve of insulation disposed on the inside of a staple adjacent to the arcuate member.

Although they comprise a protective buffer between the staple and the cable, conventional cable guards such as those proposed by these prior patents do not prevent the installer from driving the staple too far. One skilled in the art will appreciate that the installer may still drive this unitary system too far, thereby still creating abnormal force and stress on the cable. This stress may ultimately damage or even lacerate the wire. Yet another recognized problem of these types of prior cable guards is the difficulty of installation due to its multiple components. More specifically, the installer is required to hold the cable guard, wire, and/or U-shaped staple in place in order to secure the entire system onto a support surface.

Another type of cable guards typically comprises a unitary system having insulating material molded over the body portion of the U-shaped staple. For example, U.S. Pat. No. 2,526,902 discloses an insulating material molded over both the body and portions of the legs of the U-shaped staple in order to prevent contact between the wire and the metallic portion of the staple. U.S. Pat. No. 3,787,608 further discloses a piece of flexible, plastic tubing bent in the U-shaped configuration and placed around the body and portions of the legs of the U-shaped staple. A distinguishing feature of this type of cable guard is that the protective material is molded around portions of the body and legs of the U-shaped staple in order to form a unitary cable guard system. A particular advantage of this system includes ease of installation due to its unitary nature.

Although the insulation placed around the U-shaped staple serves as a buffer between the staple and the cable, this type of conventional cable guards yet again does not prevent the installer from driving the staple too far. One skilled in the art will appreciate that the installer may still drive this unitary system too far, thereby still creating abnormal force and stress on the cable. This stress may ultimately cause damage or even laceration of the wire. Although the cable guard in Pat. No. 3,787,608 is unitary in nature, securing the wire to a support surface remains difficult in that the wire and cable guard need to be held in place during installation.

Yet another variation on types of prior cable guards comprises a molded structure which serves as a buffer between the fastener and the cable. U.S. Pat. No. 2,901,200 discloses an electric cable staple having a U-shaped body of non-conductive material with legs inclined downwardly for receiving small-bodied nails for insertion into a support surface. U.S. Pat. No. 3,085,129 teaches a cable staple having an electrically insulating coated metallic bridge member having legs to provide laterally open nailways in which nails are guided into a support surface. U.S. Pat. No. 3,241,797 teaches a fastening staple comprising a bridge body having downwardly extending legs with nailways incorporating an integral friction packing projecting axially in the driving direction of the nails, thereby preventing withdrawal of the nail from the support surface.

Although the molded structure serves as a buffer between the fastener and the cable, this type of variation on conventional cable guards yet again does not prevent the installer from driving the fastener too far. One skilled in the art would appreciate that the installer may still drive this cable guard and fastener too far, thereby still creating abnormal force and stress on the cable. This stress may ultimately cause damage of the wire. Yet again, another recognized problem of this family of cable guards is the difficulty of installation due to its multiple components. More specifically, these cable guards accommodate multiple fasteners rather than a unitary U-shaped staple. Therefore, the installer is required to hold the cable guard, wire, and/or multiple fasteners in place in order to secure the entire system onto a support surface. Yet another recognized problem of this type of cable guard is that the bottom portions of their legs are flat. One skilled in the art will recognize that the support surfaces may be rounded rather than flat, i.e. securing a wire onto a pole. In this regard, conventional cable guards will not lay flush with a rounded support surface, thereby increasing the risk of accidental removal of the fastener or decreasing the insulation of the wire therein.

In view of the foregoing, it is desirable to develop a durable cable guard which accommodates a U-shaped staple.

It is further desirable to develop a cable guard that prevents the U-shaped staple from being driven too far into a support surface.

It is further desirable to develop a cable guard that simplifies installation such that the cable guard, U-shaped staple, and wire can be installed as a unitary structure.

It is further desirable to develop a cable guard having legs with bottom surfaces which conform to the support surface, thereby decreasing the likelihood of accidental removal of the fastener or providing better insulation of the wire therein.

It is further desirable to develop a cable guard that can accommodate a barbed U-shaped staple.

It is further desirable to develop a cable guard that is constructed of a high-density polypropylene or a high-impact polystyrene for durability in outdoor applications.

These and other desired benefits of the preferred forms, including combinations of features thereof, of the invention will become apparent from the following description. It will be understood, however, that a device could still appropriate the claimed invention without accomplishing each and every one of these desired benefits, including those gleaned from the following description. The appended claims, not these desired benefits, define the subject matter of the invention. Any and all benefits are derived from the preferred forms of the invention, not necessarily the invention in general.

### SUMMARY OF THE INVENTION

In view of the desired goals of the invention claimed herein, the cable guard comprises a generally U-shaped structure for receiving and securing a U-shaped staple therein. The cable guard includes a bridge body and substantially parallel legs extending perpendicularly outward therefrom. In a preferred embodiment, the top portion of the bridge body includes a recess extending inward therefrom, and each substantially parallel leg defines a respective bore therethrough. The recess of the cable guard prevents unnecessary further drive of the U-shaped staple when the U-shaped staple is sufficiently captured by the cable guard and secured onto the support surface. In another preferred embodiment, the bores of the parallel legs of the cable guard provide a force fit when mated with the legs of the U-shaped staple. The inner surfaces of the parallel legs of the cable guard provide a force fit when mated with the wire. Accordingly, a unitary system comprising the cable guard, U-shaped staple, and wire allows for easy installation. Preferably, the bottom surface of the cable guard is also slightly curved in order to conform to the support surface in which it is secured thereto. The cable guard may also accommodate barbed staples.

### BRIEF DESCRIPTION OF THE SEVERAL VIEWS OF THE DRAWINGS

Throughout this description, reference has been and will be made to the accompanying views of the drawing wherein like subject matter has like reference numerals, and wherein:

FIG. 1 is a front view of a preferred embodiment of a cable guard according to the invention;

FIG. 2 is a top view of the cable guard shown in FIG. 1;

FIG. 3 is a bottom view of the cable guard shown in FIG. 1;

FIG. 4 is perspective view of barbed staple which may be alternatively used in place of a smooth staple such as of a type shown in FIG. 5;

FIG. 5 is an exploded perspective view showing a cable guard, a U-shaped staple and a wire ready for assembly onto a utility pole;

FIG. 6 is a side view of a unitary cable guard embodiment which also includes a U-shaped staple and wire showing a system ready for installation thereof onto a utility pole;

FIG. 7 is a perspective view of a cable guard according to the invention securing a wire onto a utility pole, wherein the legs of the U-shaped staple are completely anchored into the support surface; and

FIG. 8 is a cross-sectional view of the cable guard installation which is illustrated in FIG. 7.

### DETAILED DESCRIPTION OF THE PREFERRED EMBODIMENTS

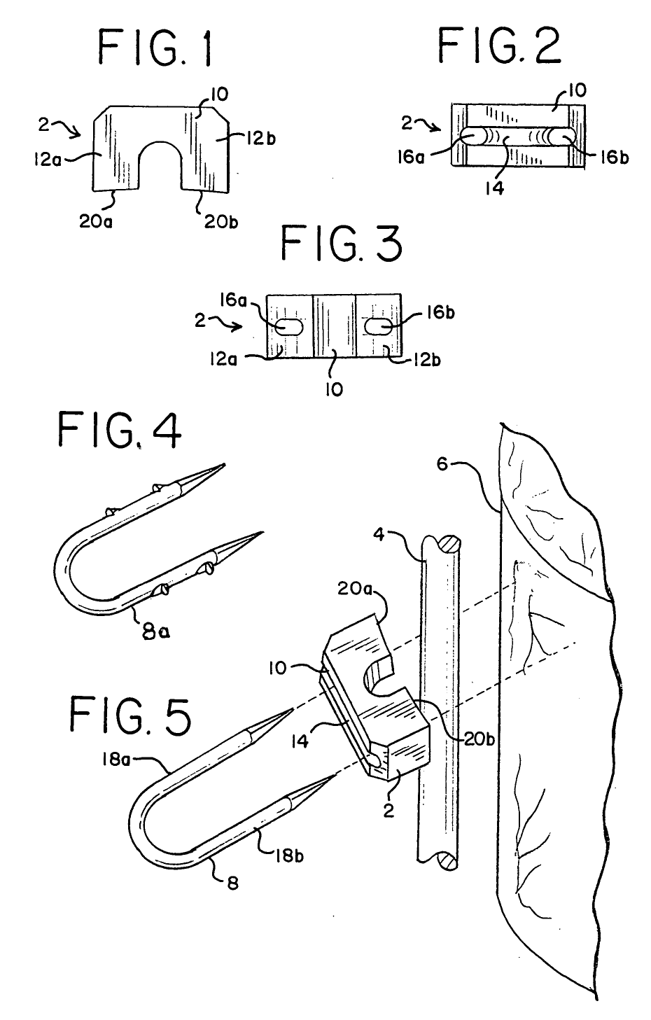

The cable guard is preferably constructed of a durable polymeric material. Suitable polymers include a high-density polypropylene, fiberglass, nylon, polyethylene, a high-impact polystyrene, or combinations of these and other polymers having very good durability in outdoor applications. It is important to note that the use of high-density polypropylene is especially desirable due to its ease of adding standard ultraviolet inhibitor therein. The general structure of a preferred embodiment of the cable guard is best illustrated in FIGS. 1, 2, and 3. The cable guard 2 is a generally U-shaped in structure for receiving and securing a U-shaped staple 8 therein. The cable guard 2 comprises a bridge body 10 and substantially parallel legs 12a, 12b extending perpendicularly outward therefrom. The top portion of the bridge body 10 includes a recess 14 extending inward therefrom, and each substantially parallel leg 12a, 12b has a respective bore 16a, 16b therethrough.

Those skilled in the art will appreciate that the corners of the top portion of the cable guard 2 are beveled in order to retard wear and tear or accidental removal thereof. Also, this cable guard 2 may be used to accommodate staples having barbs, i.e. barbed staple 8a as shown in FIG. 4. Those skilled in the art will appreciate that a barbed staple of this type is more difficult to extract from a support surface 6.

FIGS. 5, 6, 7 and 8 illustrate the installation of a wire 4 secured by the cable guard 2 and a staple 8 onto a support surface 6, in this case a utility pole. It is important to note that this cable guard 2 may be used or simply modified in order to secure a wire onto other support surfaces without departing from the scope of the invention claimed herein. As an illustration of suitable uses, the cable guard system can be sized and shaped to accommodate 3/8 inch (#6) wire or 7/16 inch (#4) wire, for example. During installation, the U-shaped staple 8 is inserted into the recess 14 of the top portion of the bridge body 10 of the cable guard 2. The bores 16a, 16b of the parallel legs 12a, 12b of the cable guard 2 receive the parallel legs 18a, 18b of the U-shaped staple 8. In order to simplify installation, the diameter of each bore 16a, 16b within each parallel leg 12a, 12b of the cable guard 2 is slightly smaller than the diameter of each leg 18a, 18b of the U-shaped staple 8, such that each leg 18a, 18b of the U-shaped staple 8 extends inwardly within each bore 16a, 16b of the cable guard 2 to create a force fit of the staple legs 18a, 18b therein. One skilled in the art will appreciate that this force fit essentially allows for a unitary cable guard 2 and U-shaped staple 8 system, thereby easing installation.

Also, the width between each innermost surface of each parallel leg 12a, 12b of the cable guard 2 is slightly smaller than the diameter of the wire 4, such that the wire 4 is secured between each parallel leg 12a, 12b of the cable guard 2 to create a force fit of the wire therein. Installation is thereby simplified in that the wire 4 may be secured by the cable guard 2 prior to being secured to the support surface 6. Therefore, those skilled in the art will appreciate that the U-shaped staple 8, cable guard 2, and wire 4 may all be secured together forming one unitary system before complete installation onto the support surface 6.

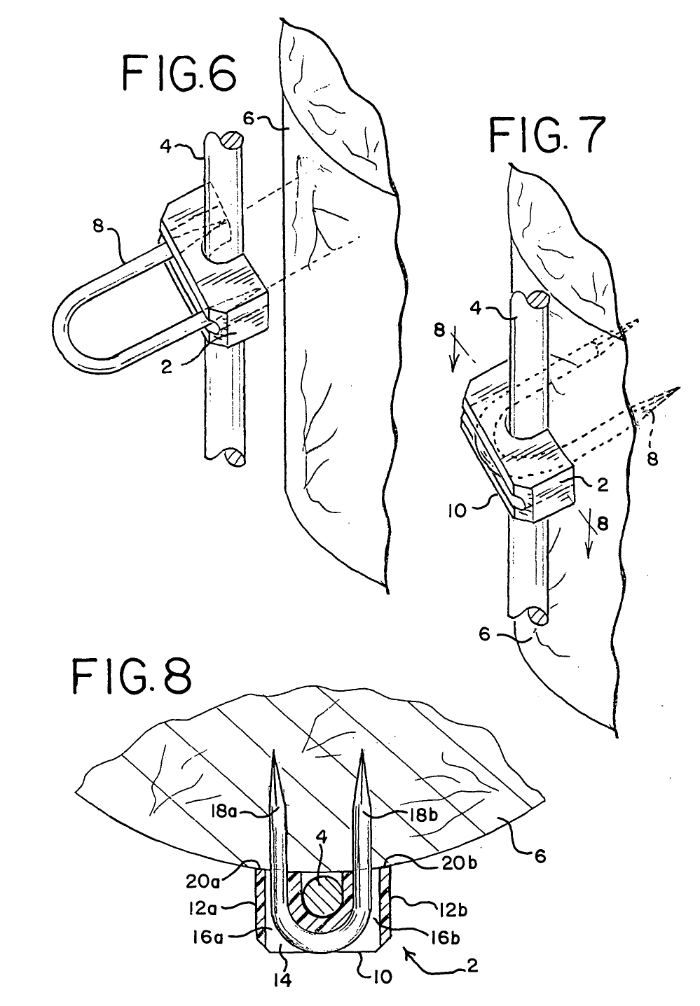

As shown in FIG. 6, in use, the unitary system of the U-shaped staple 8, cable guard 2, and wire 4 are held in place at the desired location of installation onto the support surface 6. The installer thereupon drives the U-shaped staple such that each leg 18a, 18b of the U-shaped staple 8 extends inwardly into each bore 16a, 16b of the cable guard 2, and the body portion of the U-shaped staple 8 is captured within the recess 14 of the bridge body 10 of the cable guard 2. This driving of the U-shaped staple 8 would typically be performed using a hammer or similar hand or power tool. This driving force causes each leg 18a, 18b of the U-shaped staple to protrude outwardly from the bottom surfaces 20a, 20b of each leg 12a, 12b of the cable guard 2, allowing penetration of the support surface 6. The installer then hammers the U-shaped staple 8 until the top portion of the bridge body 10 of the cable guard 2 prevents any further drive of the staple 8, thereby preventing any unnecessary force from being exerted on the wire 4 and preventing any damage of the wire 4 therein. Being bounded by the inner surface of the parallel legs 12a, 12b and the bottom portion of the bridge body 10, the wire 4 is insulated and secured onto the support surface 6.

This prevention of further drive is achieved via the recess 14 of the cable guard 2. The depth of the recess 14 of the cable guard 2 is substantially the same as, or slightly greater than, the diameter of the body portion of the U-shaped staple 8. Therefore, once the body portion of the U-shaped staple 8 is fully captured by the recess 14 of the cable guard 2, the driving force exerted onto the U-shaped staple 8 is shifted to the cable guard 2. In this way, the driving force is distributed from the top portion of the cable guard 2, through the legs 12a, 12b of the cable guard 2, and into the support surface 6. Accordingly, no driving force is exerted on the U-shaped staple 8, thereby preventing any unnecessary force from being exerted on the wire 4 and preventing any damage of the wire therein.

Preferably, each bottom surface 20a, 20b of each leg 12a, 12b of the cable guard 2 is not at a precise right angular relationship with its leg sidewall. Each such bottom surface can be at an acute angle with respect to the outside sidewall, such as angle between about 80° and 88°. Additionally, or alternatively, each such bottom surface can be slightly curved. With this feature, the bottom surface of the cable guard 2 lies flush or substantially flush with the rounded support surface 6 of the electric pole or the like. Importantly, when included, this conforming bottom surface of the cable guard 2 facilitates having all of the installer's driving force distributed through the legs 12a, 12b of the cable guard 2 rather than the wire 4 itself. If the bottom surface of the cable guard 2 did not lie generally flush with the support surface 6, unnecessary force may be exerted on the wire 4, thereby subjecting the wire 4 to potential damage. Also, because it substantially avoids gaps between the cable guard 2 and the support surface 6, this conforming bottom surface decreases the likelihood of accidental removal of the fastener while providing better insulation of the wire therein. It is important to note that bottom surface of the cable guard 2 may be modified in order to conform to other support surfaces without departing from the scope of the invention claimed herein.

While this invention has been described with reference to certain illustrative aspects, it will be understood that this description shall not be construed in a limiting sense. Rather, various changes and modifications can be made to the illustrative embodiments without departing from the true spirit and scope of the invention, as defined by the following claims. Furthermore, it will be appreciated that any such changes and modifications will be recognized by those skilled in the art as an equivalent to one or more elements of the following claims, and shall be covered by such claims to the fullest extent permitted by law. Also, references which are referred to herein above are incorporated hereinto by reference.

1. A cable guard adapted to accommodate a U-shaped staple having a rounded bridge body portion and parallel legs extending perpendicularly outward therefrom, comprising:
a bridge body having a top and bottom portion, said top portion having a recess extending inwardly therefrom and terminating at the bottom portion said bottom portion of the recess being substantially rounded, and
substantially parallel legs extending perpendicularly outward from said bridge body, each leg defining a bore therethrough and having an inner, outer, and bottom surface; wherein the substantially rounded bottom portion of the recess of the bridge body of the cable guard is sized and shaped to be complementary with and to capture therein the body portion of a U-shaped staple in abutting fashion and each leg of the cable guard is sized and shaped to capture therein legs of a U-shaped staple captured within said recess.

2. The cable guard as defined by claim 1, wherein the depth of said recess is such that the top portion of the bridge body of the cable guard prevents any excessive drive of a staple positioned within the recess.

3. The cable guard as defined by claim 1, wherein the bores within each leg of the cable guard is are sized and shaped to create a force fit with a staple positioned within the bores.

4. The cable guard as defined by claim 1, wherein the width between each inner surface of each leg of the cable guard is sized and shaped to be slightly smaller than the diameter of a wire to be secured by the cable guard to create a force fit therebetween.

5. The cable guard as defined by claim 1, wherein the bottom surface of each leg of the cable guard is adapted to lie flush with a surface to which the cable guard attaches.

6. The cable guard as defined by claim 1, wherein the top portion of the bridge body further comprises corners, wherein said corners of the bridge body are beveled.

7. The cable guard as defined by claim 1, wherein the cable guard is constructed of a durable polymer.

8. The cable guard as defined by claim 7, wherein the polymer includes an ultraviolet inhibitor.

9. The cable guard as defined by claim 1, wherein the cable guard is constructed of a high-density polypropylene.

10. The cable guard as defined by claim 1, wherein the cable guard is constructed of a high-impact polystyrene.

11. The cable guard as defined by claim 1, wherein the cable guard is constructed of a polymer selected from the group consisting of high-density polypropylene, fiberglass, nylon, polyethylene, and a high-impact polystyrene.

12. A cable guard and U-shaped staple system comprising:
a U-shaped staple having a substantially rounded bridge body portion and parallel legs extending perpendicularly outward therefrom, and
a cable guard comprising a bridge body having a top and bottom portion and substantially parallel legs extending perpendicularly outward from said bridge body, said top portion having a recess extending inwardly therefrom and terminating at the bottom portion, said bottom portion being substantially rounded, each leg defining a bore therethrough and having an inner, outer, and bottom surface; wherein the substantially rounded bottom portion of the recess of the bridge body of the cable guard is sized and shaped to capture therein the substantially rounded bridge body portion of the U-shaped staple, such that the substantially rounded bridge body portion of the U-shaped staple abuts the substantially rounded bottom portion of said recess of the bridge body when said U-shaped staple and said cable guard are secured together such that the legs of the U-shaped staple extend inwardly within the bores of each leg of the cable guard and protrude outwardly from the bottom surfaces of each leg of the cable guard to penetrate a support surface such that a wire may be secured between the support surface and said bottom portion of the bridge body and the inner surfaces of the legs of the cable guard.

13. The cable guard and U-shaped staple system as defined by claim 12, wherein the legs of the U-shaped staple are barbed.

14. The cable guard and U-shaped staple system as defined by claim 12, wherein the depth of the recess of said cable guard is substantially the same as the diameter of the body portion of the U-shaped staple, such that the top portion of the bridge body of the cable guard prevents any excessive drive of the staple.

15. The cable guard and U-shaped staple system as defined by claim 12, wherein the diameter of each bore within each leg of the cable guard is sized and shaped to be slightly smaller than the diameter of each leg of the U-shaped staple, such that each leg of the U-shaped staple extends inwardly within the bores of each leg of the cable guard to create a force fit therein.

16. The cable guard and U-shaped staple system as defined by claim 12, wherein the width between each inner surface of each leg of the cable guard is sized and shaped to be slightly smaller than the diameter of the wire, such that the wire is secured between each leg of the cable guard to create a force fit therein.

17. The cable guard and U-shaped staple system as defined by claim 12, wherein the bottom surface of each leg of the cable guard is adapted to lie flush with the support surface.

18. A combined cable guard, U-shaped staple, and wire system comprising:
a U-shaped staple having a substantially rounded bridge body portion and parallel legs extending perpendicularly outward therefrom,
a cable guard comprising a bridge body having a top and bottom portion and substantially parallel legs extending perpendicularly outward from said bridge body, said top portion having a recess extending inwardly therefrom and terminating at the bottom portion said bottom portion being substantially rounded, each leg defining a bore therethrough and having an inner, outer, and bottom surface; wherein the substantially rounded bottom portion of the recess of the bridge body of the cable guard is sized and shaped to capture therein the substantially rounded bridge body portion of the U-shaped staple, such that the substantially rounded bridge body portion of the U-shaped staple abuts the substantially rounded bottom portion of said recess of the bridge body when said U-shaped staple and said cable guard are secured together such that the legs of the U-shaped staple extend inwardly within the bores of each leg of the cable guard and protrude outwardly from the bottom surfaces of each leg of the cable guard to penetrate a support surface, and
a wire, said wire being secured between the support surface and said bottom portion of the bridge body and the inner surfaces of the legs of the cable guard when said U-shaped staple and said cable guard are secured together and secured onto the support surface.

19. The combined cable guard, U-shaped staple, and wire system as defined by claim 18, wherein said wire is a #6 type wire having a 3/8 inch diameter.

20. The combined cable guard, U-shaped staple, and wire system as defined by claim 18, wherein said wire is a #4 type wire having a 7/16 inch diameter.

21. The combined cable guard, U-shaped staple, and wire system as defined by claim 18, wherein the legs of the U-shaped staple are barbed.

22. The combined cable guard, U-shaped staple, and wire system as defined by claim 18, wherein the depth of the recess of said cable guard is substantially the same as the diameter of the body portion of the U-shaped staple, such that the top portion of the bridge body of the cable guard prevents any excessive drive of the staple.

23. The combined cable guard, U-shaped staple, and wire system as defined by claim 18, wherein the diameter of each bore within each leg of the cable guard is sized and shaped to be slightly smaller than the diameter of each leg of the U-shaped staple, such that each leg of the U-shaped staple extends inwardly within the bores of each leg of the cable guard to create a force fit wherein.

24. The combined cable guard, U-shaped staple, and wire system as defined by claim 18, wherein the width between each inner surface of each leg of the cable guard is sized and shaped to be slightly smaller than the diameter of the wire, such that the wire is secured between each leg of the cable guard to create a force fit therein.

25. The combined cable guard, U-shaped staple, and wire system as defined by claim 18, wherein the bottom surface of each leg of the cable guard is adapted to lie flush with the support surface.
